(19) United States
(12) Patent Application Publication
(10) Pub. No.: US 2021/0140207 A1
(43) Pub. Date: May 13, 2021

(54) SELF-LATCHING AUTOMATIC FLUSH-BOLT FOR DOUBLE DOORS

(71) Applicant: Michael Phillips, Fontana, CA (US)

(72) Inventor: Michael Phillips, Fontana, CA (US)

(21) Appl. No.: 16/654,716

(22) Filed: Oct. 16, 2019

Related U.S. Application Data
(60) Provisional application No. 62/781,381, filed on Dec. 18, 2018.

(51) Int. Cl. E05C 1/08; E05C 1/00

(52) U.S. Cl. CPC E05C 1/08; E05C 1/006

(57) ABSTRACT

Self-latching Automatic Flush-bolt for double doors is disclosed. This flush bolt invention eliminates the need for auxiliary coordination devices and allows for the unrestricted movement of each door to maintain security and building code compliance.

### CROSS REFERENCE TO RELATED APPLICATION

This application claims the benefit of, and incorporates by reference, U.S. provisional patent application Ser. No. 62/781,381, entitled “Self-Latching Automatic Flush-Bolt For Double Doors,” which was filed on Dec. 18, 2018.

### BACKGROUND

### 1. Field

The present general inventive concept relates generally to a bolt, and particularly, to a self-latching automatic flush-bolt for double doors.

### 2. Description of the Related Art

Existing automatic flush bolt locks require the use of auxiliary coordination devices to ensure that the individual double-doors close in a specific sequence to maintain security, fire, and smoke containment. Coordination devices are problematic, noisy, and cumbersome to the overall operation of the door opening, and they are detrimental to the door and frame.

This flush bolt invention eliminates the need for coordination devices and allows for the unrestricted closing movement of each door to maintain security and building code compliance.

### SUMMARY

The present general inventive concept provides a self-latching automatic flush-bolt.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a self-latching automatic flush-bolt to be mounted within a door leaf, including a flush-bolt assembly to extend within an interior portion of the door leaf, a latch bolt assembly connected to the flush-bolt assembly to move from at least partially locked in a door frame in a first vertical position to unlocked in a second vertical position, and a triggering bolt connected to the latch bolt assembly to move the latch bolt assembly from at least partially extended in a first vertical position to retracted in a second vertical position in response to the triggering bolt moving from retracted in a first lateral position to at least partially extended in a second lateral position, and move the latch bolt assembly from retracted in the second vertical position to at least partially extended in the first vertical position in response to the triggering bolt moving from at least partially extended in the second lateral position to retracted in the first lateral position.

The flush-bolt assembly may include a first portion, a second portion perpendicularly disposed away from an end of the first portion with respect to a first direction, and a third portion perpendicularly disposed away from the end of the first portion with respect to a second direction opposite from the first direction.

The flush-bolt assembly may further include a triggering bolt receiving aperture disposed on the end of the first portion to receive the triggering bolt therein.

The triggering bolt may retract within the triggering bolt receiving aperture in response to contact with another door leaf thereupon.

A width of the first portion may be greater than a width of the second portion and a width of the third portion.

The first portion may be parallel with respect to a top edge of the door leaf.

The first portion may be planar.

The latch bolt assembly may include a locking latch bolt to extend through a frame strike, a support bolt to connect to the triggering bolt within the flush-bolt assembly, a latch bolt rod connected at a first end to the locking latch bolt and at a second end to the support bolt to move the locking latch bolt with respect to the support bolt, and a latching spring disposed on the second end of the latch bolt rod to compress in response to the locking latch bolt contacting the frame strike, such that the locking latch bolt is retracted, and to extend in response to the locking latch bolt moving within an opening within the frame strike, such that the locking latch bolt is extended.

The latch bolt assembly may further include a base disposed on at least a portion of the flush-bolt assembly to receive the support bolt thereupon.

The self-latching automatic flush-bolt may further include a support bolt guide connected to the support bolt to provide a surface for the latching spring to compress.

The support bolt guide may at least partially surround at least a portion of the latch bolt assembly.

The support bolt guide may be substantially d-shaped.

The self-latching automatic flush-bolt may further include a latch bolt guide connected to a top edge of the door leaf to receive at least a portion of the latch bolt assembly therethrough.

The latch bolt guide may at least partially surround at least a portion of the latch bolt assembly.

The latch bolt guide may be u-shaped.

The self-latching automatic flush-bolt may further include a door leaf plate disposed against a side edge of the door leaf.

The door leaf plate may connect to the flush-bolt assembly.

The door leaf plate may connect to the latch bolt assembly.

The door leaf plate may connect to the support bolt guide.

The door leaf plate may be a planar surface.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates a front view of a self-latching automatic flush-bolt as disposed in a door leaf and locked to a door frame, according to an exemplary embodiment of the present general inventive concept;

FIG. 1B illustrates a sectional side view of the self-latching automatic flush-bolt as disposed in the door leaf, according to an exemplary embodiment of the present general inventive concept;

FIG. 2A illustrates a side view of the self-latching automatic flush-bolt, such that a triggering bolt is extended, a locking latch bolt is retracted, and a latching spring is extended, according to an exemplary embodiment of the present general inventive concept;

FIG. 2B illustrates a side view of the self-latching automatic flush-bolt, such that the triggering bolt is retracted, the locking latch bolt is extended, and the latching spring is extended, according to an exemplary embodiment of the present general inventive concept; and

FIG. 2C illustrates a side view of the self-latching automatic flush-bolt, such that the triggering bolt is retracted, the locking latch bolt is extended, and the latching spring is compressed, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

List of Components

| | |
|---|---|
| Self-Latching Automatic Flush-Bolt | 100 |
| Flush-Bolt Assembly | 110 |
| First Portion | 111 |
| Second Portion | 112 |
| Third Portion | 113 |
| Triggering Bolt Receiving Aperture | 114 |
| Latch Bolt Assembly | 120 |
| Locking Latch Bolt | 121 |
| Support Bolt | 122 |
| Base | 123 |
| Latch Bolt Rod | 124 |
| Latching Spring | 125 |
| Triggering Bolt | 130 |
| Latch Bolt Guide | 140 |
| Support Bolt Guide | 150 |
| Door Leaf Plate | 160 |

FIG. 1A illustrates a front view of a self-latching automatic flush-bolt 100 as disposed in a door leaf 10 and locked to a door frame 20, according to an exemplary embodiment of the present general inventive concept.

FIG. 1B illustrates a sectional side view of the self-latching automatic flush-bolt 100 as disposed in the door leaf 10, according to an exemplary embodiment of the present general inventive concept.

Existing automatic flush-bolt lock designs require the use of auxiliary coordination devices to ensure that the individual double-doors close in a specific sequence. Coordination devices are problematic, noisy, and cumbersome to the overall operation of the door opening, and they are detrimental to the door and frame. The invention claimed here solves this problem.

This invention uses a spring-loaded mechanism with an angled latch-bolt to provide a new benefit of making the specific closing sequence of double doors irrelevant to maintain security, fire/smoke migration. The invention eliminates the need for door coordination devices, which also increases the cost and complexity of door openings.

The claimed invention differs from what currently exists. Current flush bolt products do not allow a door to be secured if the opposing leaf closes prior to the door containing the flush-bolt lock. The existing flush-bolt locks project a flat profile locking bolt that does not allow for a latching function when the door is closed with the locking bolt projected. This leaves the door propped open when the proper sequence is not maintained. This new invention removes this burden by allowing both doors to close and secure regardless of the closing sequence, and without the use of a coordination device.

This invention is an improvement on what currently exists. Current flush bolt products do not allow a door to be secured if the opposing leaf closes prior to the door containing the flush bolt. This leaves the door propped open when the proper sequence is not maintained. This new invention removes this burden by allowing both doors to secure regardless of the closing sequence without the use of a coordination device.

Due to the need of door coordination devices, the existing flush-bolt designs do not allow for the natural operational movement of each door during the closing phase of operation. Coordination devices are often mistakenly omitted causing security and code compliance issues thus creating a hazard to life and property.

This flush-bolt invention eliminates the need for coordination devices and allows for the unrestricted closing movement of each door to maintain security and building code compliance.

Relationship Between the Components

01 Front Elevation showing the flush-bolt in application

02 Flush-bolt Assembly

03 Latching Spring

04 Latch Bolt Guide

05 Locking Latch Bolt

06 Door Frame

07 Top Strike/Receiver

How the Invention Works

A self-latching automatic flush-bolt 100 device mounted into one door leaf 10 of a double door opening.

FIG. 2A illustrates a side view of the self-latching automatic flush-bolt 100, such that a triggering bolt 130 is extended, a locking latch bolt 121 is retracted, and a latching spring 125 is extended, according to an exemplary embodiment of the present general inventive concept.

FIG. 2B illustrates a side view of the self-latching automatic flush-bolt 100, such that the triggering bolt 130 is retracted, the locking latch bolt 121 is extended, and the latching spring 125 is extended, according to an exemplary embodiment of the present general inventive concept.

FIG. 2C illustrates a side view of the self-latching automatic flush-bolt 100, such that the triggering bolt 130 is retracted, the locking latch bolt 121 is extended, and the latching spring 125 is compressed, according to an exemplary embodiment of the present general inventive concept.

The self-latching automatic flush-bolt 100 may include a flush-bolt assembly 110, a latch bolt assembly 120, a triggering bolt 130, a latch bolt guide 140, a support bolt guide 150, and a door leaf plate 160, but is not limited thereto.

The flush-bolt assembly 110 may include a first portion 111, a second portion 112, a third portion 113, and a triggering bolt receiving aperture 114, but is not limited thereto.

Referring to FIGS. 1B through 2C, the first portion 111 may be substantially planar and parallel with respect a top surface of the door leaf 10. The second portion 112 may be perpendicularly disposed away from an end of the first portion 111 with respect to a first direction. The third portion 113 may be perpendicularly disposed away from the end of the first portion 111 with respect to a second direction opposite from the first direction. Additionally, a width of the first portion 111 may be greater than a width of the second portion 112 and a width of the third portion 113.

The latch bolt assembly 120 may include a locking latch bolt 121, a support bolt 122, a base 123, a latch bolt rod 124, and a latching spring 125, but is not limited thereto.

The base 123 may be disposed on at least a portion of the first portion 111 of the flush-bolt assembly 110 to receive the support bolt 122 thereupon. The first portion 111 may extend away the second portion 112 and the third portion 113 with respect to a third direction, such that the first portion 111 may extend within an interior portion of the door leaf 10.

Referring to FIGS. 2A through 2C, the triggering bolt 130 may be disposed within at least a portion of the triggering bolt receiving aperture 114. As such, the triggering bolt receiving aperture 114 may receive the triggering bolt 130 therein.

The latch bolt guide 140 may be connected to a top edge of the door leaf 10. The latch bolt guide 140 may be u-shaped. Moreover, the latch bolt guide 140 may at least partially surround the locking latch bolt 121, such that the latch bolt guide 140 may receive the locking latch bolt 121 therethrough.

The self-latching automatic flush-bolt 100 uses triggering bolt 130 component extending from the door edge that contacts the opposing door during the closing sequence to raise a locking latch bolt 121 through the bolt guide 140 into the frame strike/receiver 21 to secure the door 10.

Once the opposing door leaf is moved away from the closed position, the triggering bolt 130 is allowed to extend. As the triggering bolt 130 extends, the connected locking latch bolt 121 is retracted into the door 10 to allow for the door 10 to unlock. In other words, the triggering bolt 130 may move (i.e. slide) from a first lateral position (i.e. retracted) to at least partially toward a second lateral position (i.e. extended) to protrude out from a side edge of the door leaf 10, such that the locking latch bolt 121 may move in a first vertical direction (i.e. down) toward the support bolt 122 in response to the triggering bolt 130 being extended. In other words, the triggering bolt 130 may be connected to the latch bolt assembly 120 within at least a portion of the flush-bolt assembly 110.

As such, the door leaf 10 may be unlocked and moved.

Alternatively, the triggering bolt 130 may move from the second lateral position to the first lateral position, such that the locking latch bolt 121 may move in a second vertical direction (i.e. up) through the top edge of the door leaf 10 in response to the triggering bolt being retracted.

As such, the door leaf 10 may be locked and prevented from moving.

The closing sequence of each door is unrestricted due to the self-latching angled locking latch bolt 121. If the locking latch bolt 121 is projected during the closing sequence through contact with the opposing leaf, the latching spring 125 allows the locking latch bolt 121 to deflect downward as it contacts the Frame Strike/Receiver 21 and re-project once aligned with the opening in the Frame Strike/Receiver 21.

In other words, the locking latch bolt 121 may move from the second position to the first position in response to the locking latch bolt 121 contacting at least a portion of a door frame 20, such as the frame strike/receiver 21, such that the locking latch bolt 121 applies a force on the latch bolt rod 124, such that the latch bolt rod 124 applies another force to the latching spring 125. Additionally, the latch bolt rod 124 moves the locking latch bolt 121 with respect to the support bolt 123. Also, the latch bolt rod 124 may connect at a first end to the locking latch bolt 121 and at a second end to the support bolt 122 to move the locking latch bolt 121 with respect to the support bolt 122. Moreover, the latching spring 125 may compress in response to the another force applied thereto.

The support bolt guide 150 may be connected to the support bolt 122. The support bolt guide 150 may be substantially d-shaped. Moreover, the support bolt guide 150 may at least partially surround the support bolt 122. Additionally, the support bolt guide 150 may be connected to the latching spring 125 to facilitate compression thereof.

The door leaf plate 160 may be disposed against the side edge of the door leaf 10. Additionally, the door leaf plate 160 may be a planar surface. The door leaf plate 160 may connect the flush-bolt assembly 110, the latch bolt assembly 120, and/or the support bolt guide 150 to the another edge of the door leaf 10.

How to Make the Invention

The flush-bolt mechanism requires the use of precision engineered and manufactured components dimensioned to allow for mechanical functionality and durability.

All the components listed are required in order to provide the self-latching functionality. The latching function satisfies the building code, safety, and security of the opening.

Creating a holding mechanism for the projecting bolt that restricts it from projecting until the flush-bolt door is in the fully closed position would create the same function.

How to Use the Invention

The existing solutions require the use of a coordination device to ensure proper closing order of each door. With the of the latching flush-bolt, the additional coordination device is no longer needed saving installation time, cost, and preventing potential operational damage to the doors and frame in the opening.

The present general inventive concept may include a self-latching automatic flush-bolt 100 to be mounted within a door leaf 10, including a flush-bolt assembly 110 to extend within an interior portion of the door leaf 10, a latch bolt assembly 120 connected to the flush-bolt assembly 110 to move from at least partially locked in a door frame 20 in a first vertical position to unlocked in a second vertical position, and a triggering bolt 130 connected to the latch bolt assembly 120 to move the latch bolt assembly 120 from at least partially extended in a first vertical position to retracted in a second vertical position in response to the triggering bolt 130 moving from retracted in a first lateral position to at least partially extended in a second lateral position, and move the latch bolt assembly 120 from retracted in the second vertical position to at least partially extended in the first vertical position in response to the triggering bolt 130 moving from at least partially extended in the second lateral position to retracted in the first lateral position.

The flush-bolt assembly 110 may include a first portion 111, a second portion 112 perpendicularly disposed away from an end of the first portion 111 with respect to a first direction, and a third portion 113 perpendicularly disposed away from the end of the first portion 111 with respect to a second direction opposite from the first direction.

The flush-bolt assembly 110 may further include a triggering bolt receiving aperture 114 disposed on the end of the first portion 111 to receive the triggering bolt 130 therein.

The triggering bolt 130 may retract within the triggering bolt receiving aperture 114 in response to contact with another door leaf thereupon.

A width of the first portion 111 may be greater than a width of the second portion 112 and a width of the third portion 113.

The first portion 111 may be parallel with respect to a top edge of the door leaf 10.

The first portion 111 may be planar.

The latch bolt assembly 120 may include a locking latch bolt 121 to extend through a frame strike 21, a support bolt 122 to connect to the triggering bolt 130 within the flush-bolt assembly 110, a latch bolt rod 124 connected at a first end to the locking latch bolt 121 and at a second end to the support bolt 122 to move the locking latch bolt 121 with respect to the support bolt 122, and a latching spring 125 disposed on the second end of the latch bolt rod 124 to compress in response to the locking latch bolt 121 contacting the frame strike 21, such that the locking latch bolt 121 is retracted, and to extend in response to the locking latch bolt 121 moving within an opening within the frame strike 21, such that the locking latch bolt 121 is extended.

The latch bolt assembly 120 may further include a base 123 disposed on at least a portion of the flush-bolt assembly 110 to receive the support bolt 122 thereupon.

The self-latching automatic flush-bolt 100 may further include a support bolt guide 150 connected to the support bolt 122 to provide a surface for the latching spring 125 to compress.

The support bolt guide 150 may at least partially surround at least a portion of the latch bolt assembly 120.

The support bolt guide 150 may be substantially d-shaped.

The self-latching automatic flush-bolt 100 may further include a latch bolt guide 140 connected to a top edge of the door leaf 10 to receive at least a portion of the latch bolt assembly 120 therethrough.

The latch bolt guide 140 may at least partially surround at least a portion of the latch bolt assembly 120.

The latch bolt guide 140 may be u-shaped.

The self-latching automatic flush-bolt 100 may further include a door leaf plate 160 disposed against a side edge of the door leaf 10.

The door leaf plate 160 may connect to the flush-bolt assembly 110.

The door leaf plate 160 may connect to the latch bolt assembly 120.

The door leaf plate 160 may connect to the support bolt guide 150.

The door leaf plate 160 may be a planar surface.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A self-latching automatic flush-bolt to be mounted within a door leaf, comprising:
a flush-bolt assembly to extend within an interior portion of the door leaf;
a latch bolt assembly connected to the flush-bolt assembly to move from at least partially locked in a door frame in a first vertical position to unlocked in a second vertical position; and
a triggering bolt connected to the latch bolt assembly to move the latch bolt assembly from at least partially extended in a first vertical position to retracted in a second vertical position in response to the triggering bolt moving from retracted in a first lateral position to at least partially extended in a second lateral position, and move the latch bolt assembly from retracted in the second vertical position to at least partially extended in the first vertical position in response to the triggering bolt moving from at least partially extended in the second lateral position to retracted in the first lateral position.

2. The self-latching automatic flush-bolt of claim 1, wherein the flush-bolt assembly comprises:
a first portion;
a second portion perpendicularly disposed away from an end of the first portion with respect to a first direction; and
a third portion perpendicularly disposed away from the end of the first portion with respect to a second direction opposite from the first direction.

3. The self-latching automatic flush-bolt of claim 2, wherein the flush-bolt assembly further comprises:
a triggering bolt receiving aperture disposed on the end of the first portion to receive the triggering bolt therein.

4. The self-latching automatic flush-bolt of claim 3, wherein the triggering bolt retracts within the triggering bolt receiving aperture in response to contact with another door leaf thereupon.

5. The self-latching automatic flush-bolt of claim 2, wherein a width of the first portion is greater than a width of the second portion and a width of the third portion.

6. The self-latching automatic flush-bolt of claim 2, wherein the first portion is parallel with respect to a top edge of the door leaf.

7. The self-latching automatic flush-bolt of claim 2, wherein the first portion is planar.

8. The self-latching automatic flush-bolt of claim 1, wherein the latch bolt assembly comprises:
a locking latch bolt to extend through a frame strike;
a support bolt to connect to the triggering bolt within the flush-bolt assembly;
a latch bolt rod connected at a first end to the locking latch bolt and at a second end to the support bolt to move the locking latch bolt with respect to the support bolt; and
a latching spring disposed on the second end of the latch bolt rod to compress in response to the locking latch bolt contacting the frame strike, such that the locking latch bolt is retracted, and to extend in response to the locking latch bolt moving within an opening within the frame strike, such that the locking latch bolt is extended.

9. The self-latching automatic flush-bolt of claim 8, wherein the latch bolt assembly further comprises:
a base disposed on at least a portion of the flush-bolt assembly to receive the support bolt thereupon.

10. The self-latching automatic flush-bolt of claim 8, further comprising:
a support bolt guide connected to the support bolt to provide a surface for the latching spring to compress.

11. The self-latching automatic flush-bolt of claim 10, wherein the support bolt guide at least partially surrounds at least a portion of the latch bolt assembly.

12. The self-latching automatic flush-bolt of claim 10, wherein the support bolt guide is substantially d-shaped.

13. The self-latching automatic flush-bolt of claim 1, further comprising:
a latch bolt guide connected to a top edge of the door leaf to receive at least a portion of the latch bolt assembly therethrough.

14. The self-latching automatic flush-bolt of claim 13, wherein the latch bolt guide at least partially surrounds at least a portion of the latch bolt assembly.

15. The self-latching automatic flush-bolt of claim 13, wherein the latch bolt guide is u-shaped.

16. The self-latching automatic flush-bolt of claim 10, further comprising:
a door leaf plate disposed against a side edge of the door leaf.

17. The self-latching automatic flush-bolt of claim 16, wherein the door leaf plate connects to the flush-bolt assembly.

18. The self-latching automatic flush-bolt of claim 16, wherein the door leaf plate connects to the latch bolt assembly.

19. The self-latching automatic flush-bolt of claim 16, wherein the door leaf plate connects to the support bolt guide.

20. The self-latching automatic flush-bolt of claim 16, wherein the door leaf plate is a planar surface.
